(19) United States
(12) Patent Application Publication
(10) Pub. No.: US 2013/0323943 A1
(43) Pub. Date: Dec. 5, 2013

(54) SMART CARD SECURING MECHANISM AND ELECTRONIC DEVICE USING SAME

(71) Applicants: FIH (Hong Kong) Limited, Kowloon (HK); SHENZHEN FUTAIHONG PRECISION INDUSTRY CO., LTD., Shenzhen (CN)

(72) Inventors: JING-YAN LI, Shenzhen (CN); YONG-GANG ZHANG, Shenzhen (CN); KUAN-HUNG CHEN, Shindian (TW)

(21) Appl. No.: 13/888,900

(22) Filed: May 7, 2013

(30) Foreign Application Priority Data
May 31, 2012 (CN) 201210175324X

(51) Int. Cl. H01R 12/00

(52) U.S. Cl. CPC H01R 9/095
USPC 439/64

(57) ABSTRACT

A smart card securing mechanism for securing two smart cards includes a base and a sliding member slidably received in the base. The sliding member accepts two smart cards in a tandem and partially overlapped manner, saving a considerable amount of internal space within an electronic device containing the smart card securing mechanism.

### BACKGROUND

1. Technical Field

The disclosure generally relates to smart card securing mechanisms, and particularly to a smart card securing mechanism of an electronic device.

2. Description of the Related Art

According to various requirements, users may need to use two different smart cards (such as SIM cards or memory cards) in an electronic device. However, a typical dual card securing mechanism takes up a large space of the electronic device.

Therefore, there is room for improvement within the art.

### BRIEF DESCRIPTION OF THE DRAWINGS

Many aspects of an exemplary smart card securing mechanism can be better understood with reference to the following drawings. The components in the drawings are not necessarily drawn to scale, the emphasis instead being placed upon clearly illustrating the principles of the exemplary smart card securing mechanism. Moreover, in the drawings, like reference numerals designate corresponding parts throughout the several views. Wherever possible, the same reference numbers are used throughout the drawings to refer to the same or like elements of an embodiment.

FIG. 1 is an exploded view of an electronic device with a smart card securing mechanism according to an exemplary embodiment.

FIG. 2 is a partially assembled view of the electronic device shown in FIG. 1.

FIG. 3 is an assembled view of the electronic device shown in FIG. 1.

FIG. 4 is a cross-sectional view of the electronic device along line IV-IV of FIG. 3.

FIG. 5 is an enlarged view of the sliding member shown in FIG. 1.

### DETAILED DESCRIPTION

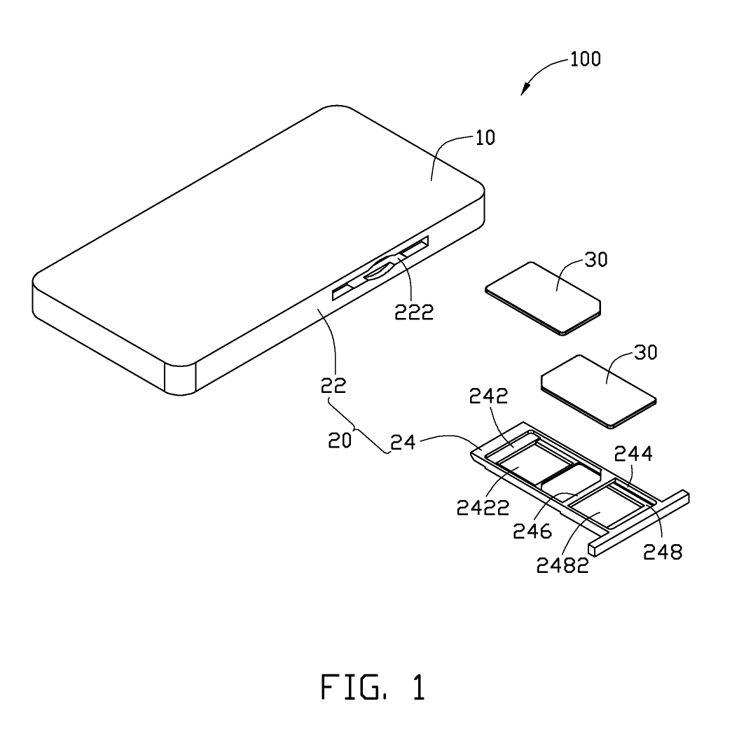

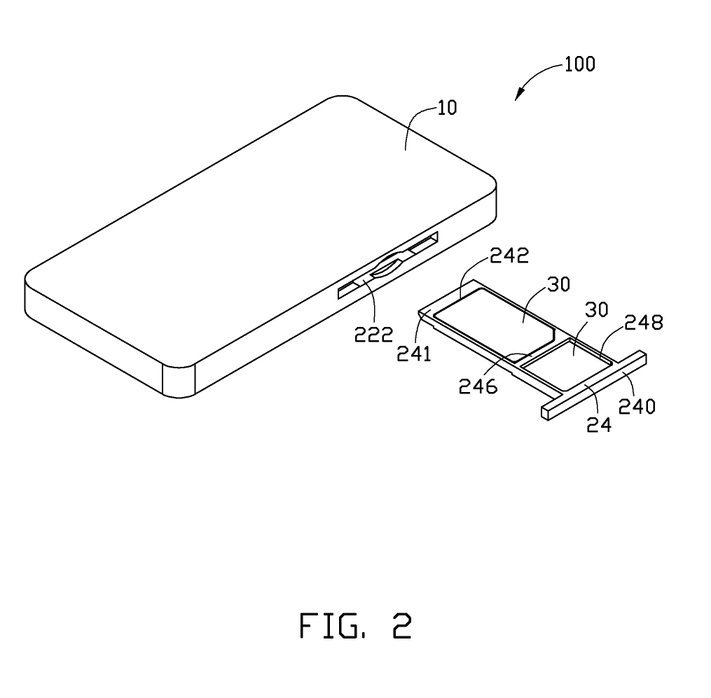

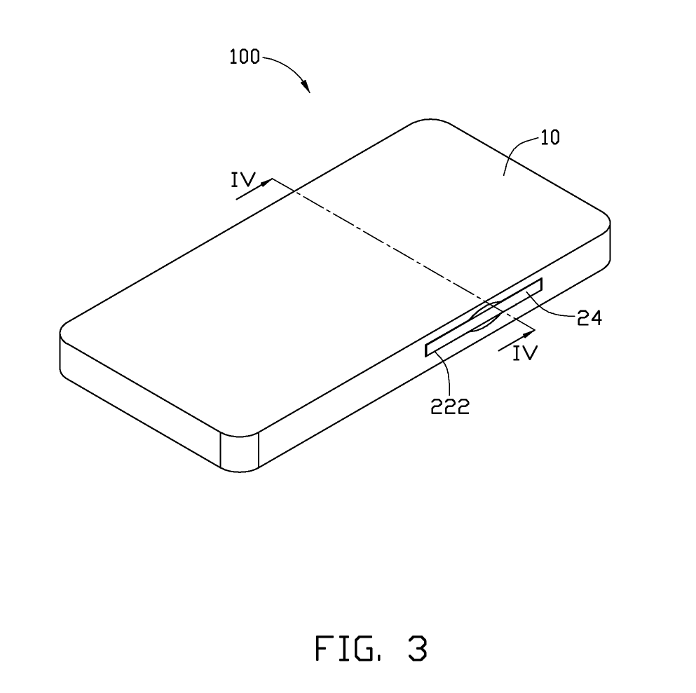

FIGS. 1-4 show a smart card securing mechanism 20 used for securing two smart cards in an electronic device 100, such as mobile phones and personal digital assistants. The electronic device 100 includes a main body 10, the smart card securing mechanism 20 and a printed circuit board 40. Two smart cards 30 can be received and secured on the smart card securing mechanism 20. The smart cards 30 can be subscriber identity module (SIM) cards or memory cards. The printed circuit board 40 is received in the main body 10.

The smart card securing mechanism 20 includes a base 22 and a sliding member 24 slidably received in the base 22. The base 22 can be a portion of the main body 10, or an independent component attached to the main body 10. In the embodiment, the base 22 is integral with the main body 10. The base 22 defines a receiving groove 222, and the sliding member 24 is slidably received in the receiving groove 222.

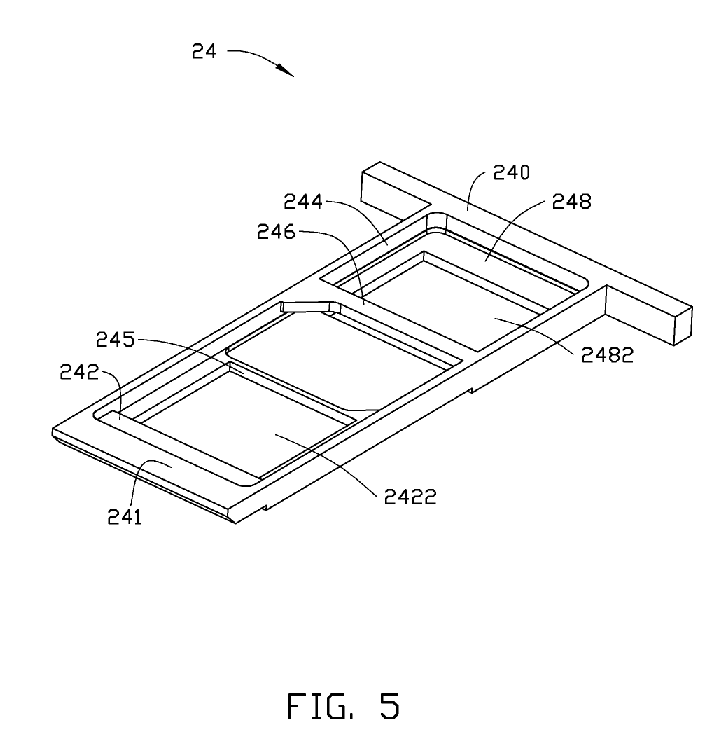

Referring to FIG. 5, the sliding member 24 is substantially T shaped and includes a first end 240 and a second end 241 opposite to the first end 240. The sliding member 24 defines a first accommodating groove 242 for receiving a smart card 30, a groove 244, and a second accommodating groove 248 for receiving another smart card 30. The first accommodating groove 242 and the groove 244 are separated by a beam 246 on one side of the sliding member 24. The first accommodating groove 242 is adjacent to the second end 241 and the groove 244 is adjacent to the first end 240. A bottom wall of the first accommodating groove 242 defines a first opening 2422. The second accommodating groove 248 is beneath the groove 244 and is longer than the groove 244. The second accommodating groove 248 is partially beneath the first accommodating groove 242 to allow the second accommodating groove 248 to partially overlap with the first accommodating groove 242. The second accommodating groove 248 and the first opening 2422 are separated by a partition 245 on another side of the sliding member 24. A bottom wall of the second accommodating groove 248 defines a second opening 2482 communicating with the groove 244.

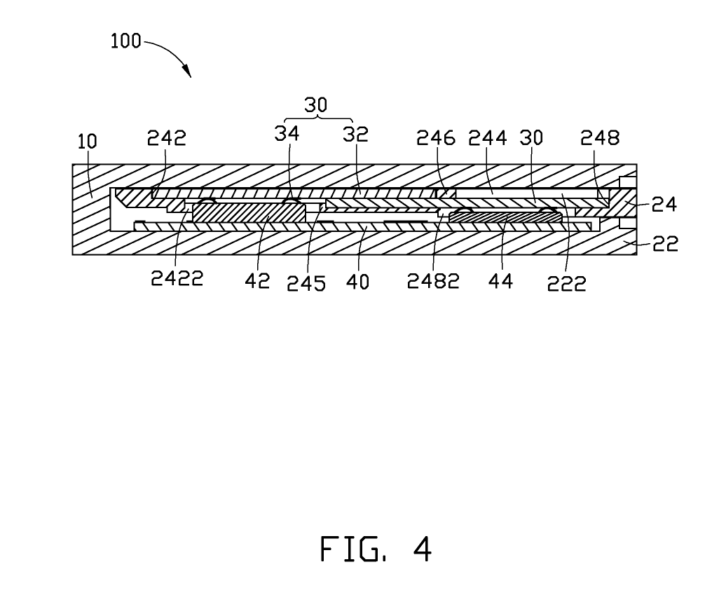

Referring to FIG. 4, each smart card 30 includes a base portion 32 and a plurality of contacts 34 located on the base portion 32. The printed circuit board 40 includes a first connector 42 and a second connector 44. The first connector 42 and the second connector 44 are located at a same side of the printed circuit board 40, and connect with the plurality of contacts 34 of the smart cards 30.

The assembly process of the electronic device 100 is as follows:

One smart card 30 is received in the first accommodating groove 242 and the plurality of contacts 34 of the smart card 30 face to the first opening 2422. The other smart card 30 is received in the second accommodating groove 248 and the plurality of contacts 34 of the other smart card 30 face to the second opening 2482. The two smart cards 30 are partially overlapped. The sliding member 24 is slid into the receiving groove 222, and the plurality of contacts 34 of the smart cards 30 make contact with the first connector 42 and the second connector 44.

The sliding member 24 is slid out of the receiving groove 222 by pulling on the first end 240. The smart card 30 is pushed out of the first accommodating groove 242 by an external force through the first opening 2422, and the other smart card 30 is also pushed out of the second accommodating groove 248 by an external force through the second opening 2482. The smart cards 30 can be easily removed from the smart card securing mechanism 20.

The two smart cards 30 are partially overlapped, and the contacts 34 are located at a same side of the sliding member 24, thus less inner space of the main body 10 is taken up by the smart card securing mechanism 20.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A smart card securing mechanism for securing two smart cards, the smart card securing mechanism comprising:
a base; and
a sliding member slidably received in the base, the sliding member defining a first accommodating groove and a second accommodating groove;
wherein the first accommodating groove partially overlaps with the second accommodating groove; the first accommodating groove and the second accommodating groove respectively receive the two smart cards.

2. The smart card securing mechanism as claimed in claim 1, wherein a bottom wall of the accommodating groove defines a first opening, and a bottom wall of the second accommodating groove defines a second opening.

3. The smart card securing mechanism as claimed in claim 2, wherein the sliding member comprises a first end and a second end opposite to the first end; the sliding member further defines a groove; the first accommodating groove is adjacent to the second end, and the groove is adjacent to the first end, the first accommodating groove and the groove are separated by a beam on one side of the sliding member; the second accommodating groove is beneath the groove and is longer than the groove, and the accommodating groove and the first opening are separated by a partition on another side of the sliding member.

4. The smart card securing mechanism as claimed in claim 3, wherein the second accommodating groove is partially beneath the first accommodating groove to allow the second accommodating groove to partially overlap with the first accommodating groove.

5. The smart card securing mechanism as claimed in claim 4, wherein the second opening communicates with the groove.

6. The smart card securing mechanism as claimed in claim 1, wherein the base defines a receiving groove, and the sliding member is slidably received in the receiving groove.

7. An electronic device, comprising:
a main body; and
a sliding member slidably received in the main body, the sliding member defining a first accommodating groove and a second accommodating groove;
wherein the first accommodating groove partially overlaps with the second accommodating groove; the first accommodating groove and the second accommodating groove respectively receive two smart cards.

8. The electronic device as claimed in claim 7, wherein a bottom wall of the accommodating groove defines a first opening, and a bottom wall of the second accommodating groove defines a second opening.

9. The electronic device as claimed in claim 8, wherein the sliding member comprises a first end and a second end opposite to the first end; the sliding member further defines a groove; the first accommodating groove is adjacent to the second end, and the groove is adjacent to the first end, the first accommodating groove and the groove are separated by a beam on one side of the sliding member; the second accommodating groove is beneath the groove and is longer than the groove, and the accommodating groove and the first opening are separated by a partition on another side of the sliding member.

10. The electronic device as claimed in claim 9, wherein a plurality of contacts of the smart card received in the first accommodating groove is aligned with the first opening, and a plurality of contacts of the smart card received in the second accommodating groove is aligned with the second opening.

11. The electronic device as claimed in claim 9, wherein the second accommodating groove is partially beneath the first accommodating groove to allow the second accommodating groove to partially overlap with the first accommodating groove.

12. The electronic device as claimed in claim 11, wherein the second opening communicates with the groove.

13. The electronic device as claimed in claim 7, wherein the main body defines a receiving groove, and the sliding member is slidably received in the receiving groove.

14. The electronic device as claimed in claim 7, wherein the electronic device further comprises a printed circuit board received in the main body, a first connector and a second connector are located at a same side of the printed circuit board and are respectively connected to a plurality of contacts of the smart cards.
